(19) United States
(12) Patent Application Publication
(10) Pub. No.: US 2004/0044663 A1
(43) Pub. Date: Mar. 4, 2004

(54) Method for asynchronous message control over a wireless network

(76) Inventor: Huba Horompoly, Redwood City, CA (US)

Correspondence Address: Randy Merritt, 15505 W. St Andrews Way, Surprise, AZ, 85374, US

(21) Appl. No.: 10/233,911

(22) Filed: Sep. 3, 2002

(51) Int. Cl. G06F 17/00

(52) U.S. Cl. 707/9

(57) ABSTRACT

The present invention describes a method for the management of activities related to asynchronous communication between information systems and remote devices. All messages between an end-user using such remote devices and an information system are queued asynchronously for delivery, with such messages including a form-style format with associated action instructions to process the forms. Examples of actions include replying to system requests, following the status of tasks being executed, and providing delivery service for action choices embedded in the message body.

### BACKGROUND OF THE INVENTION

Field of the Invention

This application is related to commonly assigned, co-pending application entitled System And Method For Dynamic Access Of Information Over A Wireless Network filed by the same inventor.

The present invention relates generally to systems that manage activities related to asynchronous communication between information systems and users using remote devices. Such communication is managed via asynchronous messaging where messages are queued for both reading and delivery where such messages would include a form-style format with associated action instructions to process the forms. Examples of actions might include replying to system requests, following the status of tasks being executed, and providing delivery services for action choices embedded in the message body. This asynchronous message queue with executable tasks embedded in messages acts as an intelligent agent, allowing remote users to not just receive static messages from an information system, but to interact with an information system in flexible ways.

### OBJECTS OF THE PRESENT INVENTION

It is therefore an object of the present invention to provide a method for managing activities related to asynchronous messages exchanged between a system and a user, based on a receiving area for messages coupled with an execution process inherent to the messages.

It is a further object of the present invention to provide a method for establishing executable content associated with a document in the form of one or more tasks that form a basis of interaction between a user and a system.

It is still a further object of the present invention to provide a method for a delivery service with action choices embedded in the message body.

It is yet a further object of the present invention to provide a method for the receiving area to automatically track the status of tasks being executed and store task output data.

It is a further object of the present invention to provide a method for the receiving area to automatically reply to system requests.

It is a further object of the present invention to provide a method for creating document types to differentiate documents with different capabilities.

It is a further object of the present invention to provide a method to intrinsically support basic text-only documents with no associated tasks.

It is a further object of the present invention to provide a method to intrinsically support documents with associated tasks that interact solely with the task originator.

It is a final object of the present invention to provide a method to intrinsically support documents with associated tasks that interact with multiple users.

### SUMMARY OF THE INVENTION

The present invention comprises a method for a repository where users can manage activities related to all asynchronous communication within a system. The present invention refers to this as the Inbox with the Inbox being essentially a receiving area for all messages between a system and a user. It also serves to log the task execution history of related activities. All messages destined for an end-user are queued asynchronously for delivery, with such messages comprising a form-style format with associated action instructions to process the forms.

### DESCRIPTION OF THE PREFERRED EMBODIMENTS

A preferred embodiment of the present invention comprises a method for a message repository system where users can manage activities related to asynchronous communication with a system. The present invention refers to this repository as the “Inbox”, with the Inbox serving as a receiving area for all asynchronous messages exchanged between a system and a user. The Inbox also serves as a log to track the task execution history of activities related to the messages. The Inbox also provides a method for a system to request information from a user by storing input forms and associated action instructions to process those forms.

The Inbox is capable of reading basic text-only messages and replying to system requests. It can track the status of Tasks being executed and store Task output data so follow-up Tasks can subsequently use the output information as input. The Inbox can also provide a delivery service for action choices embedded in the message body, such as hyperlinks, forms, and the like.

When users log into their Inbox they see a list of queued Inbox Documents. They typically view each document and, optionally, may invoke associated actions that are based on the type of document. Each document is tagged with an Inbox Document Type, which further define related attributes of a document. Depending on the type attribute, the user can perform different actions on a document. The set of Inbox Document Types is expandable by adding new Inbox Document handlers and defining corresponding schemas. Each Inbox Document Type is associated with a set of optional actions, which can be executed against the corresponding document. These Inbox Actions are typically initiated after the user has read the message.

In the present invention, actions are defined at two levels; actions that can be taken at the Inbox level, which are derived from the Inbox Document Type, and actions defined inside the Inbox document itself, which can be hyperlinks or form submissions and are independent from the disposition of the Inbox document. An Action common to all Inbox document types is the View action, which facilitates the reading of a document. Attributes common to all Inbox document types are a To attribute that lists one or more recipients of the document, a From attribute identifying the originator of the document, a Subject attribute identifying the topic of the document, a Priority attribute indicating a relative urgency to the disposition of the document, and a Body attribute comprising any combination of informational text, input forms (with input fields), and processing instructions that control the submission of the forms, if applicable. Attached Attributes common to all Inbox documents include a Received At time stamp indicating the date and time the document was received into the Inbox.

The present invention defines a set of document types that fall into three basic categories: Basic documents, Task Input-Output documents, and Task Participation documents. The Basic document type includes a text message type of document, which is comprised of essentially static text with no associated actions. Basic documents also include an Alert document type, which is a document that results from an event occurring in a backend system to which a user has subscribed. Basic documents finally include an Unknown document type, which is reserved for documents received that do not conform to any supported document types. Unknown document types display the document's message body as raw text.

Task Input-Output documents are related to the process of task execution. These documents contain information provided by a user interactively at different stages of processing as well as containing information that resulted from the execution of related tasks. Task Input-Output documents appear only to the user who initiated the corresponding task execution since these documents represent interaction solely between the user who initiated the task and a target data system. The message body of Task Input-Output documents is capable of reassembling the input/output fields of a corresponding task.

Task Input-Output document types include an Incomplete Task Input type, which is created when a user session is terminated. The document is considered incomplete because the user session terminated before the corresponding task input fields could be completed and the document submitted. This condition may occur where there are multiple input screens and the user has to send data on an earlier screen in order to continue on following screens. Additional Actions allowed for Incomplete Task Input types are Continue Task Input, which puts the user back to a first task input screen, with data previously filled in still preserved, and Cancel Task, which rolls back prior tasks steps and deletes the document.

Another document type for Task Input-Output documents is the Task In Progress type. This type is generally used as a log to indicate what information has been input into the document. A Task In Progress may contain input provided by other users, for example when someone else approved something or made a decision along the way of a task execution. These are added to the document in a read-only state with an indication as to who supplied the information. Additional Actions allowed for Task In Progress types is Check Status, which queries and reports back to a user the status of the associated task.

An additional document type for Task Input-Output documents is the Task Waiting For Input type. This type is used when a corresponding task execution reaches a branch that requires new information. Additional Actions allowed for Task Waiting For Input types are Continue, which goes to a newly requested input screen providing an opportunity for the user to fill in the requested information and continue with the task execution, and Cancel Task, which, as with the Incomplete Task Input type, rolls back prior tasks steps and deletes the document.

Another document type for Task Input-Output documents is the Task Waiting For Others type, which is used to suspend task execution because input from other sources is required to complete the document. Corresponding Inbox document types like “Approval Request” or “Decision Request” would be sent to other users and their responses would need to be received before the task could continue. Additional Actions allowed for Task Waiting For Others type is the Check Status action that queries task status and reports it back to the user, and the Cancel Task option, which, as in the case with the Task Waiting For Input type, rolls back prior tasks steps and deletes the document.

The Task Finished type is the final type of Task Input-Output document. This type of document first saves all outputs to the Inbox, in the event the user session is unexpectedly terminated, and then reassembles the inputs given and the result screen of a task. Both the inputs and outputs are to be displayed the same way as they were presented to the user on the device at task execution time. At “Inbox viewing time” the document could be viewed on a device different from that used when the document and tasks were originally done. In this case the information would be presented compatible with this new device. The Task Finished type contains any error messages if the corresponding task did not finish successfully. Additional Actions allowed for the Task Finished type is the Follow Up action, which offers a list to the user of associated follow-up tasks from which to choose. When the user picks one of the Follow Up tasks, the system starts that task, takes the output from the Inbox document and pre-fills the input fields. Another Action for the Task Finished type is the Re-execute Task action, which puts the user to the first task interaction screen with information pre-filled from the original task information in the Inbox document. If there are following task interaction screens later during the task execution, the input form is presented with any appropriate information pre-filled.

Task Participation documents are a type of Inbox document generated for users not necessarily the same as the user who started a task execution. These document types would be used where other parties would need to become involved, such as a decision needed to be made by another user or an approval required by a manager.

Task Participation document types include a Task Notification type. Notifications are generated when task execution reaches a step that defines a notification based on information available to the Task at that point. Notifications are read-only messages that can be sent out to more than one user.

An additional document type for a Task Participation document is the Decision Required type. These documents present a Task Approval (Accept/Reject/Abstain) or a Task Decision question to a user, who may not necessarily be the user who executed the task. When a decision is made the document is replaced with the appropriate Decision Made document. When there is at least one user who has yet to make a decision, the Inbox Document of this task for the user who started the task is updated to be a Task Waiting For Others document, which also will contain the question presented for decision. Additional Actions allowed for the Decision Required type is the Accept/Reject/Abstain action, which represent the choices of Accept the choice, Reject the choice, or Abstain from the decision, or the decision options presented by the task.

A final document type for a Task Participation document is the Decision Made type. These documents replace Decision Required documents once the approval/decision is made. It contains the original question as well as the choice made. This also constitutes a log of the approval/decision for the user who made the decision. Additional Actions allowed for the Decision Made type is the Delete action, which deletes the Decision Made document.

Those skilled in the art will appreciate that various adaptations and modifications of the just described preferred embodiments can be configured without departing from the scope and spirit of the invention. Therefore, it is to be understood that, within the scope of the appended claims, the invention may be practiced other than as specifically described herein.

What is claimed is:

1. A method for controlling access to and manipulation of electronic information comprising:
a plurality of interconnected computing devices each capable of interfacing to either wireless or land-based communication networks with each computing device including at least a processor and local storage;
a subset of such interconnected computing devices comprising devices of small physical stature tailored for use with a wireless network;
a subset of such interconnected computing devices comprising computing systems that contain data desired to be received by the devices of small physical stature;
a method for managing activities related to asynchronous messages exchanged between said computing systems and users based on a receiving area for said messages that couples an execution process with the messages.

2. The method of claim 1 further comprising:
a method for including executable content associated with a document in the form of one or more tasks that form a basis for interaction between a user and a system.

3. The method of claim 1 further comprising:
a delivery method that incorporates action choices embedded in the message body.

4. The method of claim 1 further comprising:
a receiving area that automatically tracks the status of tasks being executed.

5. The method of claim 1 further comprising:
a method for the receiving area to automatically reply to system requests.

6. The method of claim 1 further comprising:
a method for employing document types that differentiate documents with different capabilities.

7. The method of claim 1 further comprising:
a method to inherently support documents comprising of text only with no associated tasks.

8. The method of claim 1 further comprising:
a method to inherently support documents with associated tasks that interact solely with the task originator.

9. The method of claim 1 further comprising:
a method to inherently support documents with associated tasks that interact with multiple users.
